(19) United States
(12) Patent Application Publication
(10) Pub. No.: US 2018/0301847 A1
(43) Pub. Date: Oct. 18, 2018

(54) CONNECTOR

(71) Applicant: Molex, LLC, Lisle, IL (US)

(72) Inventors: Yuji Naito, Yamato (JP); Takeshi Kon, Yamato (JP)

(73) Assignee: Molex, LLC, Lisle, IL (US)

(21) Appl. No.: 15/948,305

(22) Filed: Apr. 9, 2018

(30) Foreign Application Priority Data
Apr. 12, 2017 (JP) 2017-078940

(51) Int. Cl. H01R 13/629

(52) U.S. Cl. CPC H01R 13/62966

(57) ABSTRACT

The present disclosure includes: housing for housing terminals; first lever which is mounted in housing to allow change of position between an initial position and a lock position, and which allows locking a mating lock member of a mating connector in the lock position; and second lever which is mounted in housing to allow change of position between an initial position and an auxiliary lock position, and which allows locking first lever at the lock position in the auxiliary lock position.

### RELATED APPLICATIONS

This application claims priority to Japanese Application No. 2017-078940, filed Apr. 12, 2017, which is incorporated herein by reference in its entirety.

### TECHNICAL FIELD

The present disclosure relates to a connector.

### BACKGROUND ART

Conventionally, connectors mating with a mating connector have an engaging lever including an engaging groove; wherein, when the engaging lever is rotated in the state in which the engaging groove engages with an engaging projection provided in the housing of the mating connector, the mating force is increased, causing the mutual connectors to be assuredly mated (for example, see Patent Document 1).

FIG. 9 is a side view illustrating a conventional connector and mating connector.

In the figure, 811 is a housing of a connector made of an insulating material, which mates with mating housing 911 of the mating connector, which is also made of an insulating material. Multiple terminals (not illustrated) are housed in housing 811. Moreover, multiple mating terminals (not illustrated) are housed in mating housing 911. Note that electric wires (not illustrated) are connected to each of the terminals and mating terminals.

Additionally, engaging projection 918 is formed on the side face of mating housing 911. Moreover, engaging lever 881, in which engaging groove 883 that can engage with engaging projection 918 is formed, is mounted in housing 811. This engaging lever 881 is mounted so as to be pivotable about pivot 875 protruding from the side face of housing 811.

While engaging lever 881 is kept in the initial position as illustrated in the figure, when housing 811 is relatively moved to the right in the figure so as to mate with mating housing 911, engaging projection 918 enters engaging groove 883 so as to be housed therein. Subsequently, when engaging lever 881 is pivoted in the clockwise direction in the figure, engaging projection 918 engages with engaging groove 883 so as to be undetachable therefrom. Additionally, if engaging lever 881 is pivoted until the upper end part of engaging lever 881 abuts upper wall 814 protruding from the upper surface of housing 811, engaging projection 815a of lock arm 815 formed on the upper surface of housing 811 engages with an engaging part formed inside the upper end part of engaging lever 881. As a result, engaging lever 881 is positioned.

Patent Document 1: JP 2009-289648 A

### SUMMARY

Unfortunately, in conventional connectors, the inside of the upper end part of engaging lever 881 engages with engaging projection 815a of lock arm 815, making it difficult to visually confirm from the outside whether engaging lever 881 has been positioned. Therefore, upon carrying out the operation to mate housing 811 and mating housing 911, engaging lever 881 may be left standing without being assuredly positioned. In this case, engaging lever 881 may be returned to the initial position, consequently releasing the mating between housing 811 and mating housing 911.

Moreover, because engaging lever 881 only engages with engaging projection 815a of lock arm 815, the engagement with engaging projection 815a may be released upon receiving external force such as an impact or vibrations, potentially causing engaging lever 881 to return to the initial position.

Herein, in order to solve the conventional problems, an object is to provide a connector such that the locking is not released even upon receiving external force such as an impact or vibrations, the mating state with a mating connector can be assuredly maintained, the structure is simple, the cost is low, and reliability is high.

Accordingly, a connector includes: a housing for housing terminals; a first lever which is mounted in the housing to allow change of position between an initial position and a lock position, and which allows locking of a mating lock member of a mating connector in the lock position; and a second lever which is mounted in the housing to allow change of position between an initial position and an auxiliary lock position, and which allows locking the first lever at the lock position in the auxiliary lock position.

In another connector, further, the first lever and the second lever are locked by a latch member.

In still another connector, further, the latch member is present at two locations in a width direction.

In still another connector, further, the second lever includes an operation piece, with the operation piece present between the latch members at two locations in the width direction.

In still another connector, further, the first lever and the second lever are swingably mounted in the housing, such that a direction in which the first lever swings from the initial position to the lock position is opposite to a direction in which the second lever swings from the initial position to the auxiliary lock position.

In still another connector, further, the mating connector includes mating terminals contactable with the terminals, and a mating housing including a peripheral wall surrounding the periphery of the mating terminals, the housing includes a recess mating with the peripheral wall, and the mating between the peripheral wall and the recess prevents displacement in a direction orthogonal to the mating release direction of the housing from the mating housing.

In still another connector, further, displacement in the mating release direction of the housing from the mating housing is prevented by the first lever locking the mating lock member.

A connector assembly includes: the connector; and the mating connector including the mating terminals contactable with the terminals, the mating lock member locked by the first lever, and the mating housing having the mating terminals and the mating lock member.

In accordance with the connector of the present disclosure, the locking is not released even upon receiving external force such as an impact or vibrations, while allowing the mating state with the mating connector to be assuredly maintained. Moreover, the structure can be simplified, enabling cost reduction, as well as improved reliability.

### BRIEF DESCRIPTION OF THE DRAWINGS

FIG. 1 is a first perspective view of a connector according to the present embodiment.

FIG. 2 is a second perspective view of the connector according to the present embodiment.

FIGS. 3A-3C are three surface views of the connector according to the present embodiment, wherein FIG. 3A is a top view, FIG. 3B is a front view, and FIG. 3C is a side view.

FIG. 4A is an exploded view of the connector according to the present embodiment.

FIG. 4B is an enlarged view of a latch projection according to the present embodiment.

FIGS. 5A-5B are perspective views of a mating connector according to the present embodiment, wherein FIG. 5A is a perspective view viewed from above, while FIG. 5B is a perspective view viewed from below.

FIG. 6 is an exploded view of the mating connector according to the present embodiment.

FIG. 7A is a side view illustrating a first step for mating the connector and the mating connector according to the present embodiment.

FIG. 7B is a side view illustrating a second step for mating the connector and the mating connector according to the present embodiment.

FIG. 8A is a side view illustrating a third step for mating the connector and the mating connector according to the present embodiment.

FIG. 8B is a side view illustrating a fourth step for mating the connector and the mating connector according to the present embodiment.

FIG. 9 is a side view illustrating a conventional connector and mating connector.

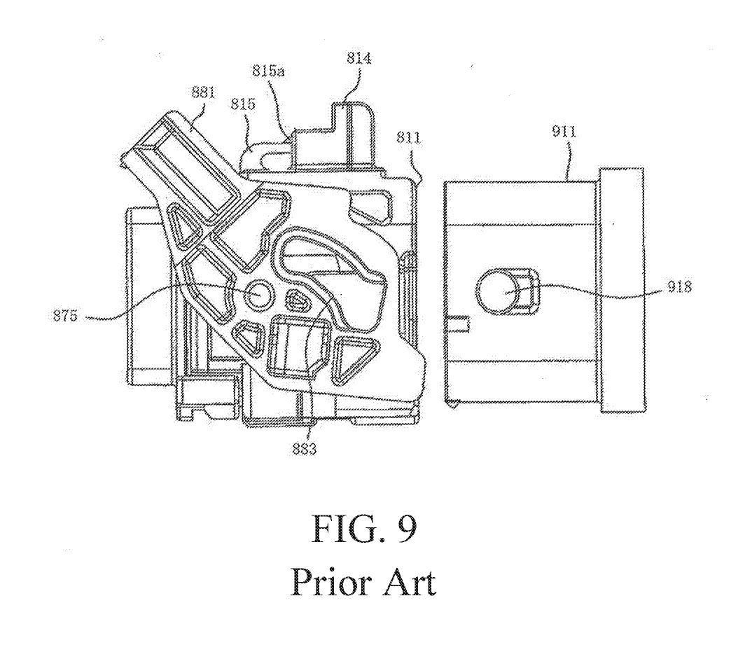

### DETAILED DESCRIPTION OF THE PREFERRED EMBODIMENTS

Embodiments will be described in detail below with reference to the drawings.

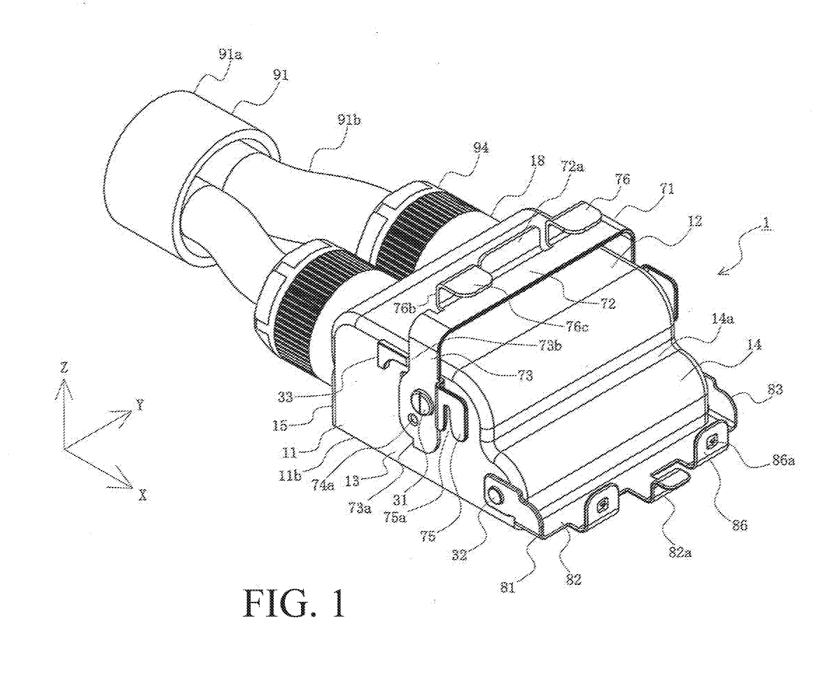

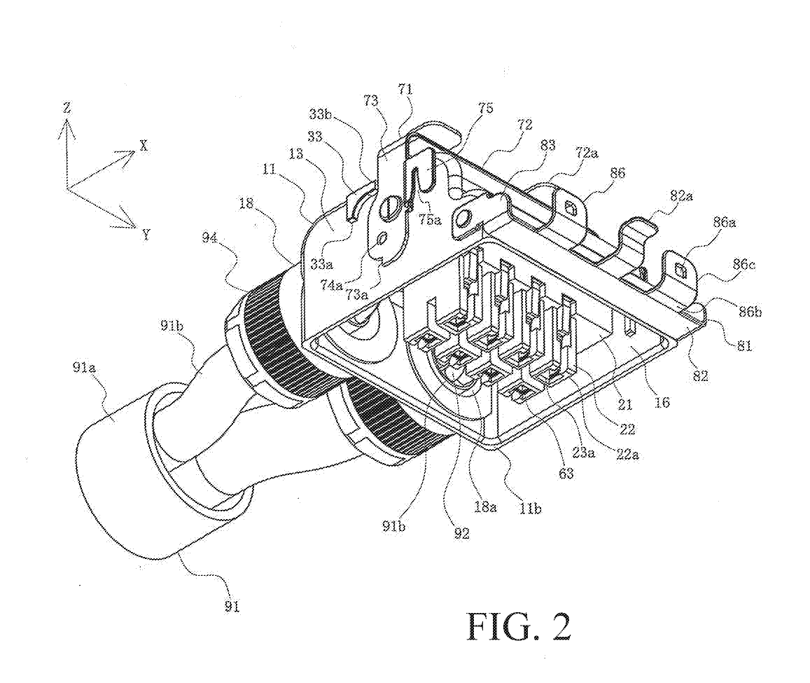

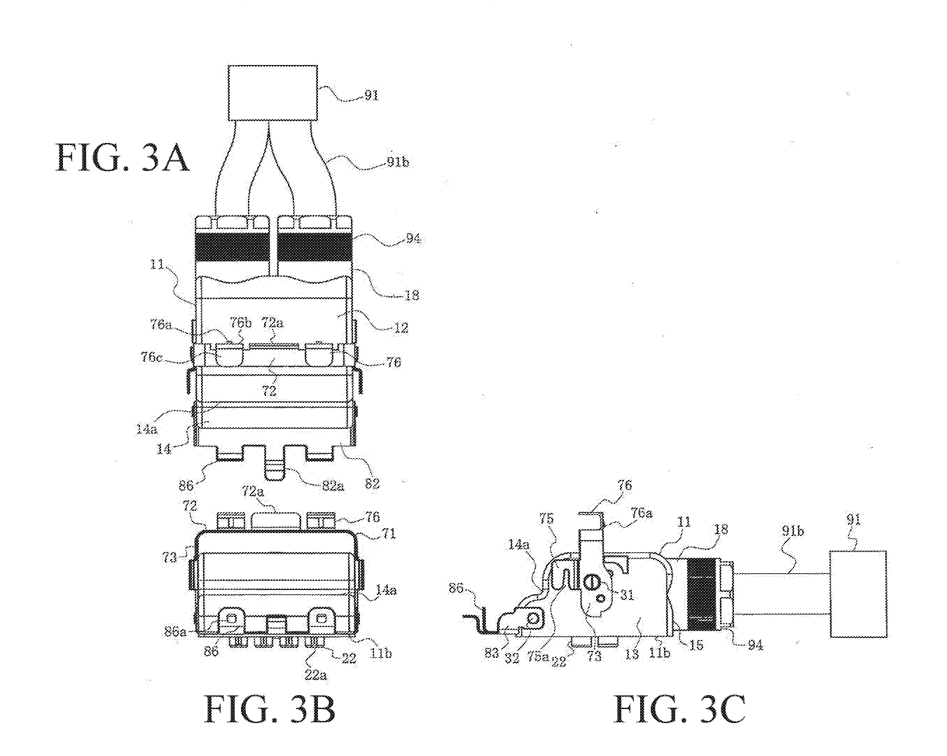

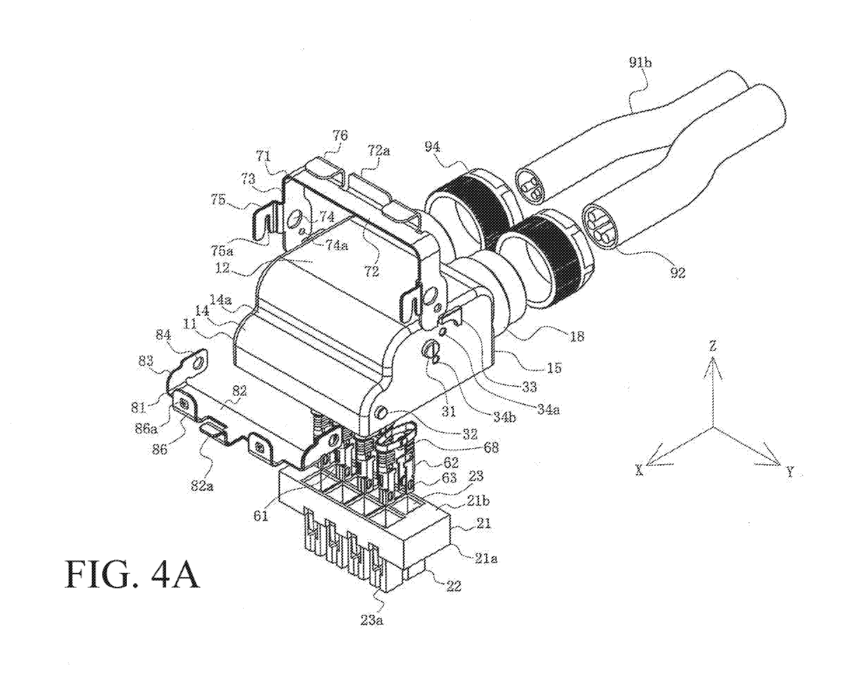

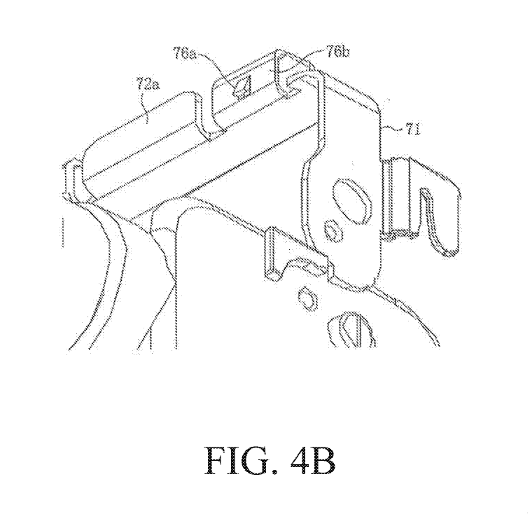

FIG. 1 is a first perspective view of a connector according to the present embodiment, FIG. 2 is a second perspective view of the connector according to the present embodiment, FIGS. 3A-3C are three surface views of the connector according to the present embodiment, FIG. 4A is an exploded view of the connector according to the present embodiment, and FIG. 4B is an enlarged view of a latch projection according to the present embodiment. Note that FIG. 3A is a top view, FIG. 3B is a front view, and FIG. 3C is a side view.

In the figures, 1 is a connector according to the present embodiment connected to the terminal of cable 91 including multiple electric wires 92, and mates with mating connector 101 described below. Connector 1 and mating connector 101, for example, are used in a variety of electronic equipment, along with a variety of equipment such as household equipment, medical equipment, industrial equipment, and transport equipment, but may be used in any application. Here, for convenience of description, these members are those as are used in transport equipment such as automobiles, as well as industrial equipment such as robots.

Note that in the present embodiment, expressions indicating directions such as up, down, left, right, front, and back that are used to describe the configuration and operation of each part included in connector 1, mating connector 101, and other members are relative and not absolute, and are suitable when each part included in connector 1, mating connector 101, and other members is in the position illustrated by the drawings; however, when the position of each part included in connector 1, mating connector 101, and other members is changed, then these expressions should be interpreted to change corresponding to the changes in positions.

Connector 1 includes housing 11 integrally formed of an insulating material such as synthetic resin, along with multiple metal terminals 61 housed in housing 11. Housing 11 is a box shaped hollow member having a substantially rectangular body that extends in the width direction, that is, the transverse direction (Y axis direction) of connector 1, the longitudinal direction, that is, the anteroposterior direction (X axis direction) of connector 1, and the thickness direction, that is, the lengthwise direction (Z axis direction) of connector 1. Additionally, housing 11 includes: top plate 12 extending in the X-Y axis direction; a pair of side walls 13 which are connected on both ends in the transverse direction of this top plate 12, and extend in the X-Z axis direction; rear plate 15 which is connected to the back (in the X axis negative direction) end of top plate 12, and extends in the Y-Z axis direction; and front plate 14 which is connected to the front (in the X axis positive direction) end of top plate 12. This front plate 14, as illustrated in FIG. 3C, in a side view, is a member having a shape substantially like two-step stairs and includes stepped recess 14a in the middle. Moreover, hollow recess 16 is formed inside housing 11. This recess 16, as illustrated in FIG. 2, opens to lower surface 11b of housing 11.

Additionally, terminal holding member 21 integrally formed of an insulating material such as synthetic resin is housed and fixed in recess 16. This terminal holding member 21 includes body part 21a having a substantially rectangular body shape, along with multiple (eight in the example illustrated in the figure) pillar shaped terminal holding parts 22 protruding downward (in the Z axis negative direction) from the lower surface of this body part 21a. Moreover, multiple (eight in the example illustrated in the figure) terminal housing recesses 23 are formed in terminal holding member 21. Each terminal housing recess 23 passes through the inside of each terminal holding part 22 and body part 21a, extends in the vertical direction (Z axis direction), and opens to lower surface 22a of each terminal holding part 22 and upper surface 21b of body part 21a. Additionally, each terminal 61 is housed in each terminal housing recess 23. Note that the portion which opens to lower surface 22a of terminal holding part 22 in terminal housing recess 23 functions as mating terminal receiving opening 23a into which mating terminal 161 can enter as described below.

Each terminal 61 includes: body part 62; contact part 63 connected to the tip, that is, the lower end of this body part 62; and electric wire connecting part 68 connected to the back end, that is, the upper end of body part 62. Additionally, each terminal 61, as illustrated in FIG. 4, is housed and held in corresponding terminal housing recess 23 at the position in which contact part 63 is directed downward, while electric wire connecting part 68 is directed upward (in the Z axis positive direction). Note that conductive core wires of corresponding electric wires 92 are connected to electric wire connecting part 68. Moreover, contact part 63 contacts mating terminal 161 which enters terminal housing recess 23 from mating terminal receiving opening 23a.

Although cable 91 is a long narrow member, in the figure, for convenience, the illustration of the whole cable is omitted, with only the vicinity of connector 1 illustrated. In the example illustrated in the figure, cable 91 includes eight electric wires 92, with four electric wires 92 as one set housed in each of two internal insulation tubes 91b. Note that two internal insulation tubes 91b are housed in cylindrical outermost insulation coat 91a included in cable 91. Additionally, the terminal of each internal insulation tube 91b is connected to cable connecting part 18 protruding backward (in the X axis negative direction) from rear plate 15 of housing 11, via pressing ring 94. As illustrated in FIG. 2, the terminal of internal insulation tube 91b is housed in internal space part 18a of cable connecting part 18, while each of electric wires 92 stretching from the terminal of internal insulation tube 91b passes through the inside of recess 16 of housing 11 and is connected to electric wire connecting part 68 of corresponding terminals 61 held by terminal holding member 21.

First lever 71 for locking to hold the mating state between connector 1 and mating connector 101, as well as second lever 81 for holding the lock state of this first lever 71, is mounted outside housing 11. First lever 71 and second lever 81 may be made of any material, but are desirably formed by subjecting a metal plate material such as stainless steel to processing such as cutting or bending. As a result, even if first lever 71 and second lever 81 are relatively thin members, sufficient strength can be maintained, allowing for these members to be elastically deformed but not plastically deformed upon the application of strong force thereto.

In the example illustrated in the figure, first lever 71 substantially has a U shape or arch shape overall. Specifically, first lever 71 includes first body part 72 linearly extending in the transverse direction (Y axis direction), along with a pair of first legs 73 which are connected on both ends of this first body part 72 and stretch in the direction orthogonal to the direction in which first body part 72 extends. Additionally, as illustrated in FIG. 4, bearing opening 74 serving as a circular through opening is formed in each first leg 73 and rotatably fitted to the periphery of first pivot 31 fixed to the outer face of side walls 13 of housing 11. As a result, first lever 71 is mounted in housing 11 so as to potentially swing about first pivot 31. Note that the position in the anteroposterior direction (X axis direction) of first pivot 31 corresponds to the center in the anteroposterior direction on lower surface 11b of housing 11. That is, first pivot 31 is disposed in the approximate center in the anteroposterior direction of housing 11.

Moreover, for the case in which the position of first lever 71 relative to housing 11 is the initial position as illustrated in FIGS. 1 and 2, as well as the position in which first legs 73 extend in the Z axis direction, lock member 75, which engages with mating lock member 175 as described below, is connected to the side end at the front (in the X axis positive direction) of each first leg 73. Lock recess 75a as a lock part is formed in this lock member 75. For the case in which the position of first lever 71 relative to housing 11 is the position in which first legs 73 extend in the Z axis direction as illustrated in FIGS. 1 and 2, this lock recess 75a is a groove recess extending in the vertical direction (Z axis direction) so as to open the lower end thereof.

Further, for example, circular small projection 74a serving as a swollen part formed by press processing is formed in the vicinity of bearing opening 74 of each first leg 73. This small projection 74a is a portion which swells toward the outer face of side walls 13 of housing 11, and therefore, as illustrated in FIGS. 1 and 2, is recessed when viewed from the outside of first legs 73. In contrast, first small recess 34a and second small recess 34b, which can engage with small projection 74a, are formed on the outer face of side walls 13 of housing 11. Additionally, for the case in which the position of first lever 71 is the initial position, small projection 74a engages with second small recess 34b, such that the initial position of first lever 71 is maintained. Moreover, as mentioned below, for the case in which the position of first lever 71 is the lock position in which first legs 73 extend in the X axis direction, small projection 74a engages with first small recess 34a, such that the lock position of first lever 71 is maintained. That is, small projection 74a, as well as first small recess 34a and second small recess 34b, functions as a lever side position maintaining part and housing side position maintaining part for maintaining the position of first lever 71.

Further, positioning projection 33 for positioning first lever 71 is formed on the outer face of side walls 13 of housing 11. In contrast, notch 73a is formed at the tip of each first leg 73 as a lever side positioning part for positioning first lever 71 by abutting first positioning part 33a of positioning projection 33. Moreover, the side end at the back (in the X axis negative direction) of each first leg 73, with the position of first lever 71 serving as the initial position, becomes linear part 73b as the lever side positioning part for positioning first lever 71 by abutting second positioning part 33b of positioning projection 33.

Additionally, for the case in which the position of first lever 71 is the initial position, when first lever 71 swings in the direction in which first body part 72 is displaced further backward, linear part 73b abuts second positioning part 33b of positioning projection 33. As a result, first lever 71 is positioned. Moreover, for the case in which the position of first lever 71 is the lock position, when first lever 71 swings in the direction in which first body part 72 is displaced further downward, notch 73a abuts first positioning part 33a of positioning projection 33. As a result, first lever 71 is positioned.

Operation piece 72a is connected to the central part in the transverse direction (Y axis direction) of first body part 72, while lock state holding member 76 is connected on both ends in the transverse direction of this operation piece 72a. Operation piece 72a is a member for improving the operability of first lever 71 when operated by the finger of an operator or the like, and stretches upward from the side end at the back of first body part 72 for the case in which the position of first lever 71 is the initial position. Moreover, lock state holding member 76, as illustrated in FIG. 3C, is a plate member winding in a chevron shape in the side view, and has body part 76b stretching upward from the side end at the back of first body part 72 for the case in which the position of first lever 71 is the initial position, along with auxiliary plate part 76c stretching forward from the upper end (tip) of this body part 76b; and further, latch projection 76a protruding backward is formed on body part 76b. Additionally, for the case in which the position of first lever 71 is the initial position, first body part 72 is separated from top plate 12 of housing 11 so as to be disposed above this top plate 12. Moreover, for the case in which the position of first lever 71 is the lock position, the side end opposite the side end connected to operation piece 72a in first body part 72 approaches or abuts stepped recess 14a of front plate 14 of housing 11.

In the example illustrated in the figure, second lever 81 substantially has a U shape or arch shape overall. Specifically, second lever 81 includes second body part 82 linearly extending in the transverse direction (Y axis direction), along with a pair of second legs 83 which are connected on both ends of this second body part 82 and stretch in the direction orthogonal to the direction in which second body part 82 extends. Additionally, as illustrated in FIG. 4, bearing opening 84 serving as a circular through opening is formed in each second leg 83 and rotatably fitted around the periphery of second pivot 32 fixed on the outer face of side walls 13 of housing 11. As a result, second lever 81 is mounted in housing 11 so as to potentially swing about second pivot 32. Note that second pivot 32 is disposed in the vicinity at the front (in the X axis positive direction) end of housing 11, and in the side view, disposed about a circular arc drawn by the portion on the lower side of front plate 14.

Moreover, for the case in which the position of second lever 81 relative to housing 11 is the initial position as illustrated in FIGS. 1 and 2, as well as the position in which second legs 83 extend in the X axis direction, the side end at the back (in the X axis negative direction) of second body part 82 abuts the lower end of front plate 14 of housing 11, such that the initial position of second lever 81 is maintained. Note that when second lever 81 swings about second pivot 32, the position can be changed from the initial position to the auxiliary lock position in which second legs 83 extend in the Z axis direction.

Operation piece 82a is connected to the central part in the transverse direction (Y axis direction) of second body part 82, while lock state holding member 86 is connected on both ends in the transverse direction of this operation piece 82a. Operation piece 82a is a member for improving the operability upon operating second lever 81 when operated by the finger of an operator or the like, and stretches forward from the side end at the front of second body part 82 for the case in which the position of second lever 81 is the initial position. Moreover, lock state holding member 86, as illustrated in FIG. 3C, is a plate member winding in a chevron shape in the side view and includes connecting part 86b stretching forward from the side end at the front of second body part 82 for the case in which the position of second lever 81 is the initial position, along with body part 86c stretching upward from the front end (tip) of this connecting part 86b; and further, latch hole 86a serving as a through hole is formed on this body part 86c.

Additionally, for the case in which the position of first lever 71 is the lock position, when second lever 81 is changed from the initial position to the auxiliary lock position, body part 86c of lock state holding member 86 is overlapped with the upper side of body part 76b of lock state holding member 76 of first lever 71, and latch hole 86a formed in body part 86c engages with latch projection 76a of lock state holding member 76 of first lever 71. As a result, first lever 71 is auxiliarily locked by second lever 81, preventing any change in position from the lock position. Note that because latch projection 76a is a latch member having a triangular side face shape such that the surface on the auxiliary plate part 76c side is an inclined face, and the end on the first body part 72 side is nearly orthogonal to body part 76b, the engagement with latch hole 86a tends not to be released, allowing the auxiliary locking between first lever 71 and second lever 81 to be assuredly maintained. The shape of latch projection 76a illustrated in the figure is only one example and can be appropriately changed to a square side face or the like, but is preferably a shape having an inclined face on the auxiliary plate part 76c side so as to be easily locked. Moreover, latch hole 86a is not necessarily a through hole, but may be a dent shape or the like Further, latch projection 76a may be formed on second lever 81, while latch hole 86a may be formed in first lever 71.

Note that, as required, in order to EMI shield signals passing through the inside, the vicinity of the terminal of cable 91 and the periphery of housing 11 can be covered with a shield member made of a conductive metal plate. Moreover, ground terminals obtained by connecting some of multiple terminals 61 to ground lines may also be used.

Next, the configuration of mating connector 101 will be described in detail.

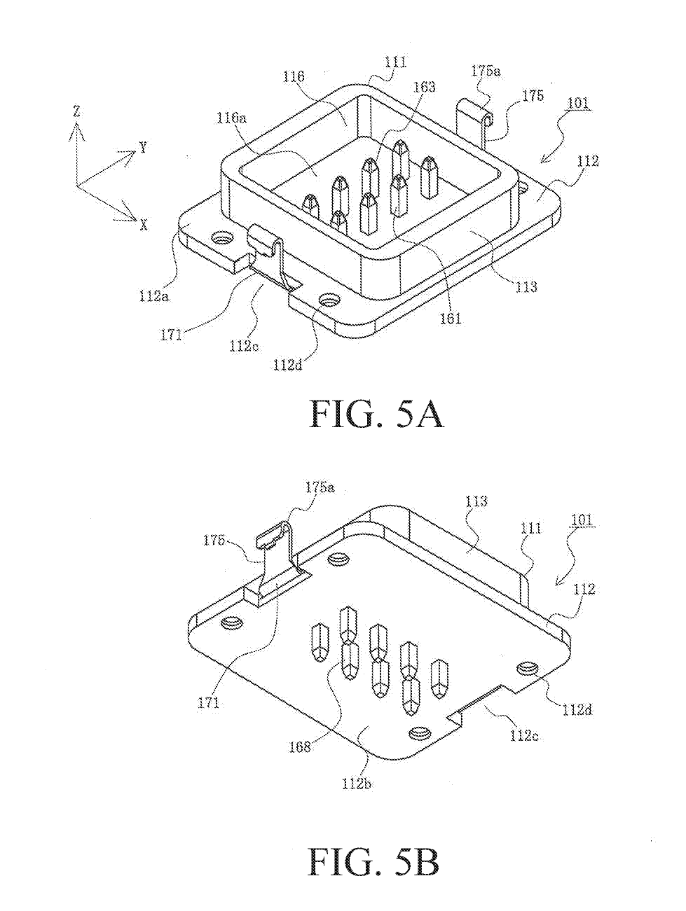

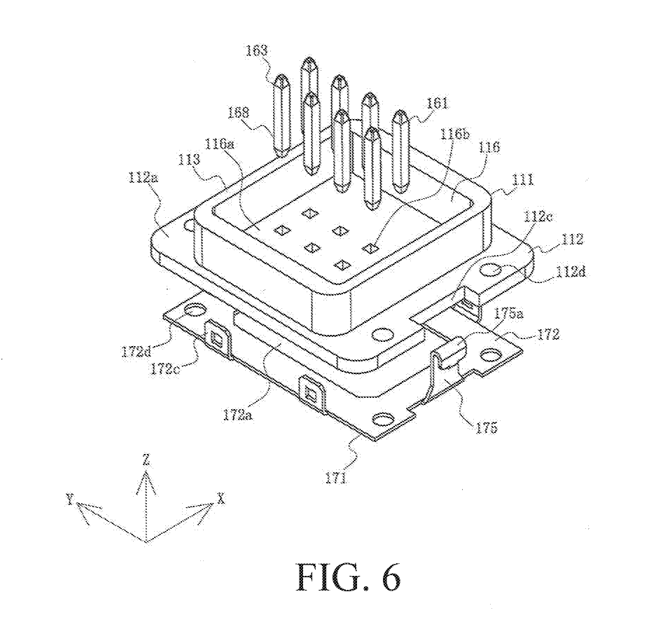

FIGS. 5A-5B are a perspective views of a mating connector according to the present embodiment, while FIG. 6 is an exploded view of the mating connector according to the present embodiment. Note that FIG. 5A is a perspective view viewed from above, while FIG. 5B is a perspective view viewed from below.

As illustrated in the figure, mating connector 101 includes: mating housing 111 as a housing integrally formed of an insulating material such as synthetic resin; multiple (eight in the example illustrated in the figure) metal mating terminals 161 installed in this mating housing 111; and reinforcing member 171 integrally coupled to mating housing 111. Here, for convenience of description, mating connector 101 is mounted on a side wall or the like of a cabinet for storing electrical equipment, electronic equipment, or the like in transport equipment such as automobiles, as well as industrial equipment such as robots, and is electrically connected to electrical equipment, electronic equipment, or the like provided inside the cabinet.

Mating housing 111 includes substrate 112 extending in the X-Y axis direction, along with peripheral wall 113 stretching upward (in the Z axis positive direction) from upper surface 112a of this substrate 112. Additionally, linear bar shaped mating terminal 161 is mounted on this substrate 112 so as to pass through substrate 112 in the Z axis direction, such that the periphery thereof is surrounded by peripheral wall 113. Moreover, when viewed in the Z axis direction, peripheral wall 113 is a substantially rectangular cylindrical member and surrounds the periphery of mating terminals 161 with four mutually connected planar walls. Further, mounting holes 112d serving as through holes are formed in portions outside peripheral wall 113 of substrate 112, and mounting members such as bolts and pins necessary for mounting mating connector 101 on the side walls of the cabinet or the like pass through these holes.

Hollow recess 116 is formed inside peripheral wall 113. The upper end of this recess 116 is opened, while the lower end thereof is defined by recess bottom surface 116a serving as a portion of upper surface 112a of substrate 112. Note that this recess bottom surface 116a is desirably disposed so as to be lower than upper surface 112a outside peripheral wall 113, that is, in the Z axis negative direction. Additionally, as illustrated in FIG. 6, multiple (eight in the example illustrated in the figure) terminal housing holes 116b are formed on recess bottom surface 116a, with mating terminals 161 inserted and fixed in each of these terminal housing holes 116b. Note that while this mating terminal 161 is a member having the same cross sectional shape over the entire length, here, the portion exposed above recess bottom surface 116a is referred to as contact part 163, while the portion exposed below lower surface 112b of substrate 112 is referred to as connecting part 168 and is electrically connected to electrical equipment, electronic equipment, or the like, which are provided inside the cabinet.

Reinforcing member 171 may be made of any material, but is desirably formed by subjecting a metal plate material such as stainless steel to processing such as cutting or bending. In the example illustrated in the figure, reinforcing member 171 includes flat plate body part 172, along with mating lock member 175 stretching upward from both ends in the transverse direction (Y axis direction) of this body part 172. Body part 172 is a portion embedded in substrate 112 for the case in which reinforcing member 171, for example, is integrally coupled to mating housing 111 by a molding method referred to as insert molding or overmolding. Note that auxiliary part 172c stretching upward from both ends in the anteroposterior direction (X axis direction) of body part 172 is embedded in peripheral wall 113. Moreover, each peripheral through hole 172d formed in body part 172 corresponds to each mounting hole 112d formed in a portion outside peripheral wall 113 of substrate 112. Further, central through hole 172a formed in body part 172 is formed so as to be larger than the range of a group of terminal housing holes 116b formed on recess bottom surface 116a, such that reinforcing member 171 does not contact mating terminal 161.

With reinforcing member 171 integrally coupled to mating housing 111, mating lock member 175 stretches upward from notch part 112c formed on both ends in the transverse direction of substrate 112. Additionally, locking bent part 175a as a lock part is formed on the upper end of mating lock member 175.

Note that mating connector 101 has an axisymmetric shape in which the line passing through the center in the anteroposterior direction (X axis direction) is the symmetric axis. Additionally, the position in the anteroposterior direction (X axis direction) of reinforcing member 171 corresponds to the center in the anteroposterior direction on lower surface 112b of substrate 112. That is, locking bent part 175a is disposed in the approximate center in the anteroposterior direction of mating housing 111.

Next, the operation to mate connector 1 and mating connector 101 as configured above will be described.

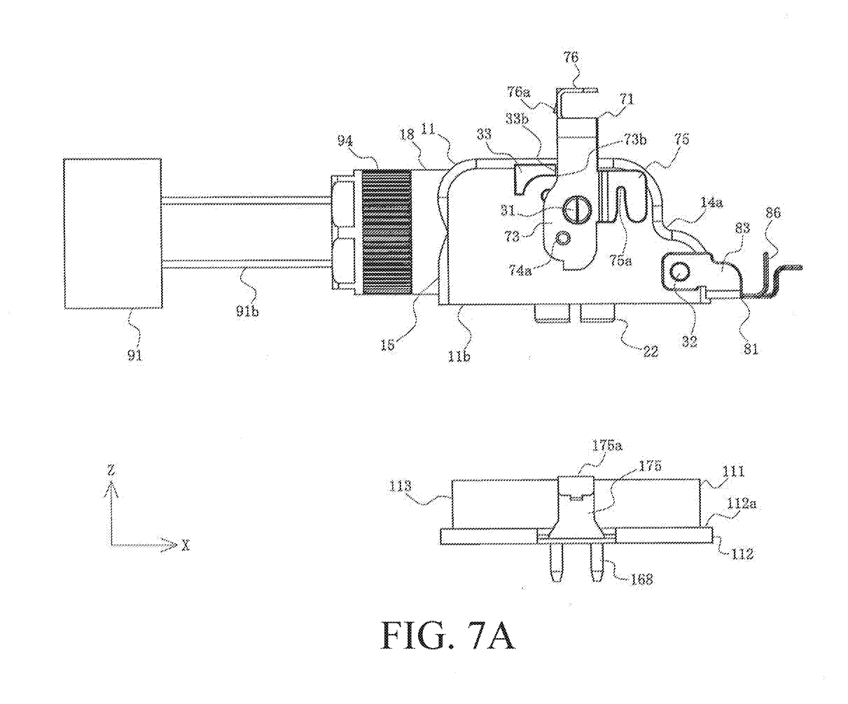

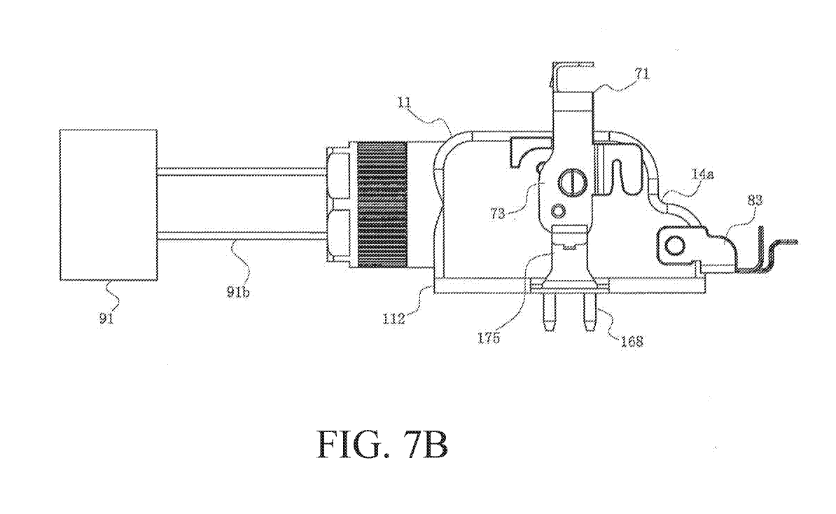

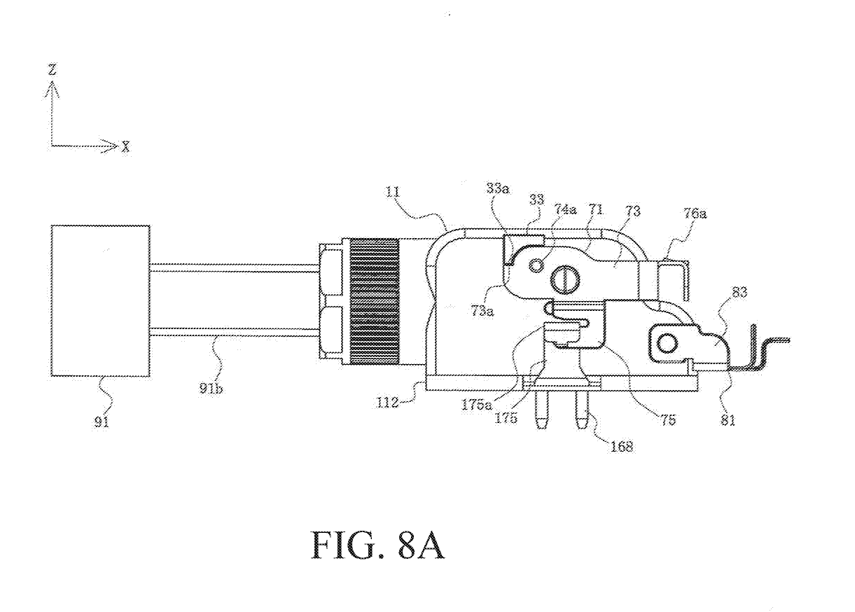

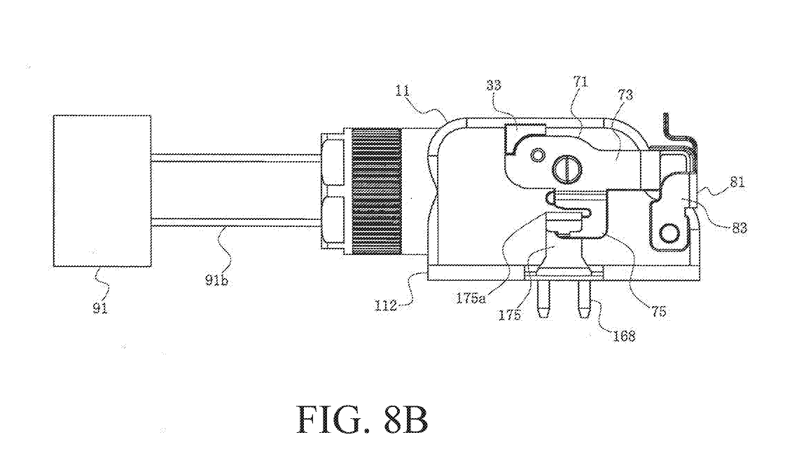

FIGS. 7A-7B are side views illustrating the first step and the second step for mating the connector and the mating connector according to the present embodiment, while FIGS. 8A-8B are side views illustrating the third step and the fourth step for mating the connector and the mating connector according to the present embodiment. Note that FIG. 7A is a view illustrating the first step and FIG. 7B is a view illustrating the second step, while FIG. 8A is a view illustrating the third step and FIG. 8B is a view illustrating the fourth step.

In order to mate connector 1 and mating connector 101, an operator holds connector 1 by finger or the like, and as illustrated in FIG. 7A, sets the position such that lower surface 11b of housing 11 serving as the mating face of connector 1 is opposite upper surface 112a of substrate 112 serving as the mating face of mating connector 101. Note that mating connector 101 is mounted and fixed to the side walls or the like of the cabinet for storing electrical equipment, electronic equipment, or the like, in advance. Moreover, the position of first lever 71 and second lever 81 is set to the initial position in advance.

Subsequently, the operator makes connector 1 relatively approach mating connector 101, makes peripheral wall 113 of mating housing 111 enter recess 16 of housing 11, and also makes contact part 163 of each mating terminal 161 enter mating terminal receiving opening 23a which opens to lower surface 22a of corresponding terminal holding part 22. Additionally, lower surface 11b of housing 11 is made to approach or abut upper surface 112a of substrate 112. As a result, as illustrated in FIG. 7B, connector 1 and mating connector 101 are mated together, and contact part 163 of each mating terminal 161 contacts contact part 63 of each terminal 61 housed in terminal housing recess 23 of corresponding terminal holding part 22, so as to be conducted together.

Note that the dimension in the X axis direction and Y axis direction outside peripheral wall 113 is set to be slightly smaller than the dimension in the X axis direction and Y axis direction inside recess 16. As a result, with peripheral wall 113 entering recess 16, the outer face of peripheral wall 113 and the inner face of recess 16 face together so as to approach or abut each other, allowing peripheral wall 113 to mate with recess 16 without any play. Accordingly, connector 1 and mating connector 101 mated together are precisely aligned and not displaced together even if an external force is received in the mating direction or the X axis direction and Y axis direction orthogonal to the mating release direction (Z axis direction).

Subsequently, the operator operates operation piece 72a by finger or the like, and changes the position of first lever 71 from the initial position to the lock position. Thereupon, lock member 75 swings about first pivot 31 and is displaced in the Z axis negative direction and the X axis negative direction; wherein, as illustrated in FIG. 8A, lock recess 75a formed in lock member 75 engages with locking bent part 175a formed in mating lock member 175, immediately below first pivot 31. As a result, connector 1 and mating connector 101 are locked in the mating state, preventing the mating therebetween from being released.

Subsequently, the operator operates operation piece 82a by finger, or the like, and changes the position of second lever 81 from the initial position to the auxiliary lock position. Thereupon, lock state holding member 86 swings about second pivot 32 and is displaced in the Z axis positive direction and X axis negative direction; wherein, as illustrated in FIG. 8B, body part 86c of lock state holding member 86 overlaps with the upper side of body part 76b of lock state holding member 76 of first lever 71, while latch hole 86a formed in body part 86c engages with latch projection 76a of lock state holding member 76 of first lever 71. As a result, because first lever 71 is auxiliarily locked by second lever 81, first lever 71 is prevented from changing position from the lock position even if an external force is received such as an impact or vibrations, such that the mating between connector 1 and mating connector 101 is assuredly prevented from being released.

Note that, as mentioned above, mating connector 101 has an axisymmetric shape in which the line passing through the center in the anteroposterior direction is the symmetric axis, and locking bent part 175a is disposed in the approximate center in the anteroposterior direction of mating housing 111. Moreover, first pivot 31 serving as the center of swinging of lock member 75 in connector 1 is disposed in the approximate center in the anteroposterior direction of housing 11, while lock recess 75a engages with locking bent part 175a immediately below first pivot 31. Accordingly, even if the orientation in the anteroposterior direction of connector 1 is opposite the orientation illustrated in FIGS. 7A-7B and FIGS. 8A-8B, connector 1 can mate with mating connector 101.

In this way, in the present embodiment, connector 1 includes: housing 11 for housing terminals; first lever 71 which is mounted in housing 11 to allow change of position between an initial position and a lock position, and which allows locking of mating lock member 175 of mating connector 101 in the lock position; and second lever 81 which is mounted in housing 11 to allow change of position between an initial position and an auxiliary lock position, and which allows locking of first lever 71 at the lock position in the auxiliary lock position.

As a result, the locking of mating lock member 175 is not released by first lever 71 even if an external force is received such as an impact or vibrations, allowing the mating state with mating connector 101 to be assuredly maintained. Additionally, the structure of connector 1 can be simplified, enabling cost reduction, as well as improved reliability.

Moreover, first lever 71 and second lever 81 are locked by latch projection 76a serving as a latch member. Further, latch projection 76a is present at two locations in the width direction. Accordingly, the locking of first lever 71 is assuredly maintained by second lever 81.

Further, second lever 81 includes operation piece 82a, with operation piece 82a present between latch projections 76a at two locations in the width direction. Accordingly, the operator can easily operate second lever 81 and lock first lever 71.

Further, first lever 71 and second lever 81 are swingably mounted in housing 11, such that the direction in which first lever 71 swings from the initial position to the lock position is opposite the direction in which second lever 81 swings from the initial position to the auxiliary lock position. Accordingly, the operator can easily and assuredly carry out the operation of first lever 71 and second lever 81. Moreover, locking of first lever 71 by second lever 81 can be confirmed visually.

Further, mating connector 101 includes mating terminals 161 contactable with terminals 61, along with mating housing 111 including peripheral wall 113 surrounding the periphery of mating terminals 161, housing 11 includes recess 16 that mates with peripheral wall 113, and the mating between peripheral wall 113 and recess 16 prevents displacement in the direction (X-Y axis direction) orthogonal to the mating release direction (Z axis direction) of housing 11 from mating housing 111. Moreover, displacement in the mating release direction of housing 11 from mating housing 111 is prevented by first lever 71 locking mating lock member 175. Accordingly, connector 1 and mating connector 101 mated together are not displaced together even upon receiving external force.

Note that the disclosure of the present specification describes characteristics related to preferred and exemplary embodiments. Various other embodiments, modifications and variations within the scope and spirit of the claims appended hereto could naturally be conceived by persons skilled in the art by summarizing the disclosures of the present specification.

The present disclosure can be applied to connectors.

1. A connector, comprising:
a housing for housing terminals;
a first lever which is mounted in the housing to allow change of position between an initial position and a lock position, and which allows locking of a mating lock member of a mating connector in the lock position; and
a second lever which is mounted in the housing to allow change of position between an initial position and an auxiliary lock position, and which allows locking of the first lever at the lock position in the auxiliary lock position.

2. The connector according to claim 1, wherein the first lever and the second lever are locked by a latch member.

3. The connector according to claim 2, wherein the latch member is present at two locations in a width direction.

4. The connector according to claim 3, wherein the second lever includes an operation piece, with the operation piece present between the latch members at two locations in the width direction.

5. The connector according to claim 1, wherein the first lever and the second lever are swingably mounted in the housing such that a direction in which the first lever swings from the initial position to the lock position is opposite to a direction in which the second lever swings from the initial position to the auxiliary lock position.

6. The connector according to claim 1, wherein:
the mating connector comprises mating terminals contactable with the terminals, and a mating housing including a peripheral wall surrounding the periphery of the mating terminals;
the housing includes a recess mating with the peripheral wall; and
mating between the peripheral wall and the recess prevents displacement in a direction orthogonal to a mating release direction of the housing from the mating housing.

7. The connector according to claim 6, wherein displacement in the mating release direction of the housing from the mating housing is prevented by the first lever locking the mating lock member.

8. A connector assembly, comprising:
the connector according to claim 1; and
the mating connector including the mating terminals contactable with the terminals, the mating lock member locked by the first lever, and the mating housing having the mating terminals and the mating lock member.
